(19) United States
(12) Patent Application Publication
(10) Pub. No.: US 2003/0000143 A1
(43) Pub. Date: Jan. 2, 2003

(54) Desulphurisation

(75) Inventors: Bernard J. Crewdson, North Yorkshire (GB); Peter EJ Abbott, Cleveland (GB); Martin Fowles, North Yorkshire (GB)

Correspondence Address: PILLSBURY WINTHROP, LLP, P.O. BOX 10500, MCLEAN, VA, 22102, US

(73) Assignee: Imperial Chemical Industries PLC, London (GB)

(21) Appl. No.: 10/222,905

(22) Filed: Aug. 19, 2002

Related U.S. Application Data
(63) Continuation of application No. PCT/GB01/00564, filed on Feb. 9, 2001.

(30) Foreign Application Priority Data
Feb. 17, 2000 (GB) 0003574.1
Aug. 4, 2000 (GB) 0019039.7

(51) Int. Cl. C01B 3/32; C10L 3/00

(52) U.S. Cl. 48/127.5; 48/127.7

(57) ABSTRACT

Desulphurization of a hydrocarbon feedstock by subjecting a portion of said feedstock to a pre-treatment step of partial oxidation, optionally in the presence of a catalyst, or adiabatic low temperature catalytic steam reforming, thereby forming a gas stream containing hydrogen, and then passing the resultant hydrogen-containing pre-treated gas stream, together with the remainder, of said hydrocarbon feedstock, through a bed of a hydro-desulphurization catalyst and then through a bed of a particulated absorbent capable of absorbing hydrogen sulphide.

This invention relates to desulphurisation and in particular to desulphurisation of a hydrocarbon feedstock that is to be subjected to a downstream catalytic process, such as steam reforming. Desulphurisation is necessary because many catalysts used for downstream processing of hydrocarbons are poisoned by sulphur compounds which are generally present in hydrocarbon feedstocks.

Some sulphur compounds, such as hydrogen sulphide and carbonyl sulphide, can be removed simply by passing the feedstock through a bed of a sulphur absorbent at an elevated temperature. Often zinc oxide, carbonate or basic carbonate compositions are used for removing hydrogen sulphide and carbonyl sulphide at temperatures in the range 100 to 250° C. Other sulphur compounds however, such as mercaptans, disulphides and thiophenes are not readily removed simply by such a sulphur absorbent. In order to remove such organic sulphur compounds, it is conventional to subject the feedstock to a hydro-desulphurisation step wherein the feedstock, together with hydrogen, is passed at an elevated temperature, typically in the range 150 to 300° C., through a bed of a hydro-desulphurisation catalyst, typically a molybdate of cobalt and/or nickel. The organic sulphur compounds are reduced, producing hydrogen sulphide, which can then be removed by a particulate sulphur absorbent as aforesaid.

However hydro-desulphurisation requires a source of hydrogen. In many processes a source of hydrogen is available and indeed where the hydrocarbon feedstock is subjected to processes such as steam reforming, hydrogen is produced and some of this hydrogen can be recycled to provide the hydrogen required for hydro-desulphurisation. For example EP1002779 describes a process wherein a hydrocarbon feedstock is subjected to hydro-desulphurisation, sulphur removal and catalytic steam reforming with recycle of a portion of the product reformed gas via an ejector, to provide hydrogen for the hydro-desulphurisation step. U.S. Pat. No. 4,976,747 and U.S. Pat. No. 4,181,503 describe processes for producing hydrogen for fuel cells where oxygen is removed from natural gas by adding a hydrogen-rich gas to the natural gas and feeding the mixture to an oxidiser prior to hydrodesulphurisation, hydrogen sulphide absorption, steam reforming and shift reactions. The hydrogen-rich gas is provided by recycling part of the product from the shift reaction that follows the steam-reforming step. In some processes however, recycle of hydrogen is inconvenient.

The present invention is concerned with effecting desulphurisation where an external source of hydrogen is unavailable and recycle of hydrogen from downstream is inconvenient

It has been proposed, in GB2050413, to remove organic sulphur compounds from a feedstock prior to reforming by subjecting the feedstock and steam to temperatures above 800° C. in the presence of an alkaline absorbent disposed in the reformer tubes before the feedstock contacts the reforming catalyst. This however necessitates the use of uneconomically large reformer units.

Accordingly the present invention provides a process for the desulphurisation of a hydrocarbon feedstock containing sulphur compounds comprising subjecting a portion of said feedstock to a pre-treatment step of partial oxidation, optionally in the presence of a catalyst, or adiabatic low temperature catalytic steam reforming, thereby forming a gas stream containing hydrogen, and then passing the resultant hydrogen-containing pre-treated gas stream, together with the remainder of said hydrocarbon feedstock, through a bed of a hydro-desulphurisation catalyst and then through a bed of a particulate absorbent capable of absorbing hydrogen sulphide

The hydrocarbon feedstock will normally contain hydrogen sulphide as well as organic sulphur compounds Typically, it will have a total sulphur content of 1 to 500 ppm by weight of which typically 50 to 90% is organic sulphur

The invention is of particular applicability where the hydrocarbon feedstock contains no free hydrogen or an amount that is insufficient for adequate hydro-desulphurisation. Generally the feedstock will contain less than 1% particularly less than 0.5%, by volume of hydrogen, but a hydrogen content in the range 0.5 to 1.5% by volume is desirable for adequate hydro-desulphurisation

In order to minimise de-activation of any catalyst used in the pre-treatment step, the portion of the hydrocarbon feedstock subjected to the pre-treatment may be subjected to a step of desulphurisation using a particulate absorbent capable of absorbing hydrogen sulphide and/or some organic sulphur compounds prior to the aforesaid pre-treatment Thus easily removed sulphur compounds such as hydrogen sulphide can be removed prior to the pre-treatment, but the hydrocarbon feedstock fed to the pre-treatment will normally contain some organic sulphur compounds

In the process of the invention, a part stream taken from the hydrocarbon feedstock is subjected to the pre-treatment step Typically the part stream subjected to the pre-treatment represents a minor portion of the stream, preferably 1 to 45% and more preferably 5 to 25% by volume of the total hydrocarbon stream. Separation of the part stream from the feedstock may be effected by the use of a throttle in the main supply of feedstock to force the flow of a part stream through the pre-treatment step. Alternatively, a steam ejector may be employed that uses a stream of steam to effect the driving force required to cause the part stream to flow through the aforementioned pre-treatment step.

The pre-treatment may be adiabatic low temperature catalytic steam reforming, which is often otherwise termed pre-reforming In such a process steam is added to the hydrocarbon feedstock and the mixture passed adiabatically at a inlet temperature in the range 300-600° C. particularly 400-550° C. through a bed of a low temperature reforming catalyst, which is typically nickel, ruthenium, platinum or rhodium on a suitable support Preferred catalysts are the products of reducing a composition containing co-precipitated nickel and aluminium compounds. The reduced catalyst preferably contains at least 40% by weight, and preferably at least 50% by weight of nickel The amount of steam added is preferably 0.5 to 3 moles of steam per gram atom of hydrocarbon carbon in the portion of the hydrocarbon stream fed to the pre-treatment stage During passage through the catalyst bed, adiabatic steam reforming takes place giving a hydrogen-containing gas stream.

Alternatively the pre-treatment may be partial oxidation wherein the feedstock is partially combusted with an oxygen-containing gas, e.g air Steam may be added to the partial oxidation feed and, if desired, the partial oxidation may be effected in the presence of a suitable catalyst Examples of suitable partial oxidation catalysts include nickel, platinum, rhodium, ruthenium, iridium and/or palladium on an oxidic support such as alumina, calcium aluminate cement, rare earth oxides titania, zirconia, magnesia and calcium oxide Other suitable catalysts for partial oxidation include mixed metal oxides such as Perovskites and pyrochore materials.

During the pretreatment, the following reactions can be considered to occur

CₙHₘ+n H₂O ---->n CO+½(n+m) H₂

(where CₙHₘ represents any hydrocarbons present containing 2 or more carbon atoms)

CO+3H₂<===>CH₄+H₂O

CO+H₂O<===>CO₂+H₂

and, where the pre-treatment is partial oxidation also

CₙHₘ+n/2O₂--->n CO+m/2H₂

(where CₙHₘ represents any hydrocarbons present containing 2 or more carbon atoms)

CH₄+½O₂---->CO+2 H₂

H₂+½O₂---->H₂O

The extent to which the reactions proceed, and hence the outlet composition and temperature, depends on the nature of the hydrocarbon feedstock, the proportion of steam and/or oxygen, the prevailing pressure, the inlet temperature and the activity of the catalyst, if used. Since the feedstock fed to the pre-treatment step contains sulphur compounds, these will tend to poison and de-activate the catalyst and so the extent of reaction when effected with a catalyst will be less than would be obtained under similar conditions using a sulphur-free feedstock However sufficient reaction will occur to provide a gas stream containing some hydrogen.

Where the sulphur content of the portion of the feedstock to be subjected to the pre-treatment, after any initial step of hydrogen sulphide or organic sulphur absorption, contains more than 20 ppm by weight sulphur, the pre-treatment is preferably non-catalytic partial oxidation.

After the pre-treatment, the pre-treated gas stream is mixed with the remainder of the hydrocarbon feedstock and then subjected to hydro-desulphurisation e.g. using a nickel and/or cobalt molybdate hydro-desulphurisation catalyst. The proportion of feedstock that is subjected to the pre-treatment and the conditions employed for the pre-treatment are preferably such that the feed to the hydro-desulphurisation catalyst contains at least 0.5% by volume of hydrogen Typically hydro-desulphurisation is effected at a temperature in the range 150 to 400° C. After passage through the bed of hydro-desulphurisation catalyst, hydrogen sulphide is removed from the gas stream by passage through a bed of a suitable particulate absorbent. Examples of such absorbents are compositions containing zinc oxide, zinc carbonate or basic zinc carbonate. Alternatively, or additionally, copper-containing absorbents may be employed In such copper-containing compositions, the copper will normally be in the reduced state as a result of the hydrogen present in the gas stream. The copper-containing compositions may also contain zinc and/or aluminium compounds

The resultant desulphurised gas stream may be used for a variety of purposes but the invention is of particular utility where the desulphurised gas stream is to be subjected to steam reforming to produce hydrogen eg. for use in a fuel cell, or synthesis gas for the production of methanol or ammonia or higher hydrocarbons, e.g by the Fischer-Tropsch reaction

Three embodiments of the invention are illustrated by reference to the accompanying drawings wherein

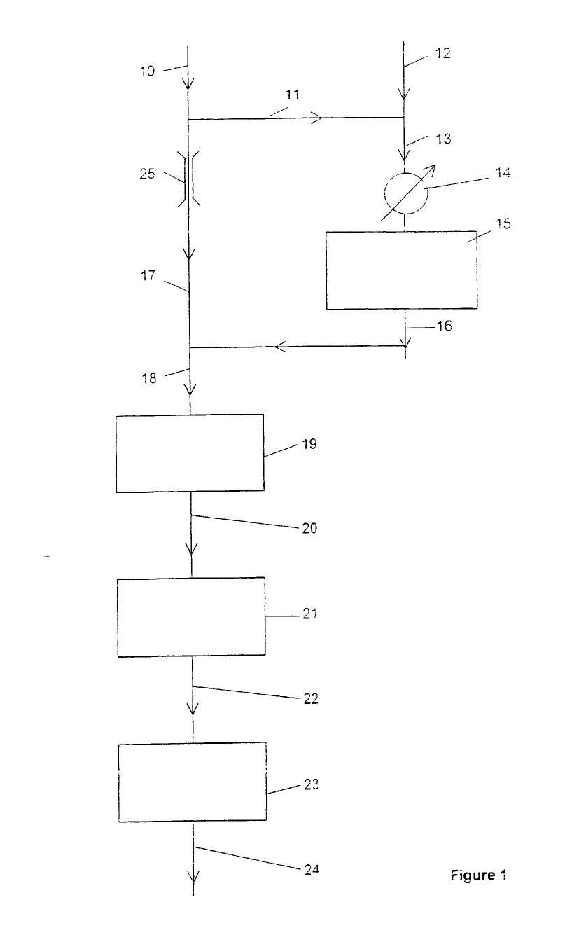

FIG. 1 is a diagrammatic flow sheet of a process in accordance with a first embodiment of the invention

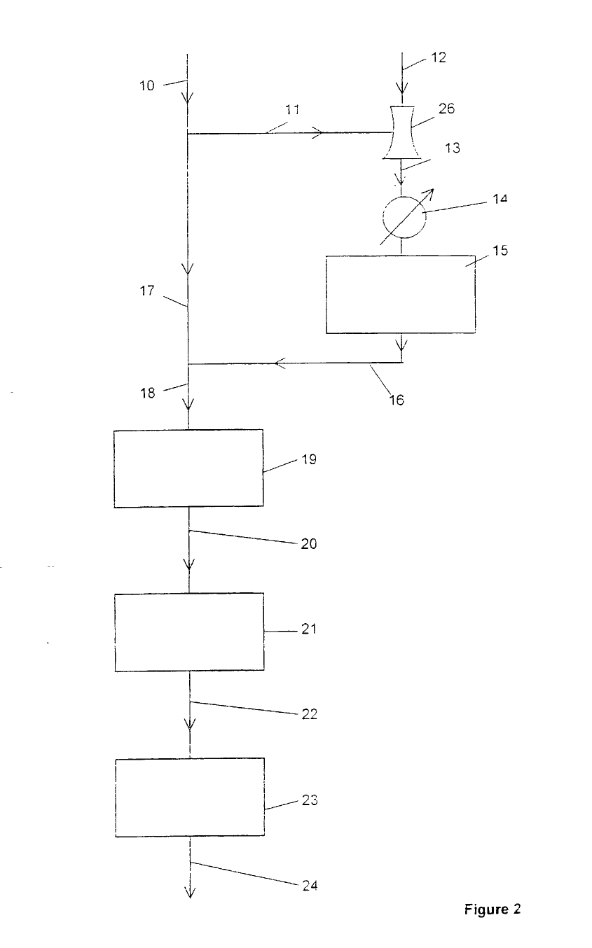

FIG. 2 is a diagrammatic flow sheet of a process in accordance with a second embodiment of the invention and

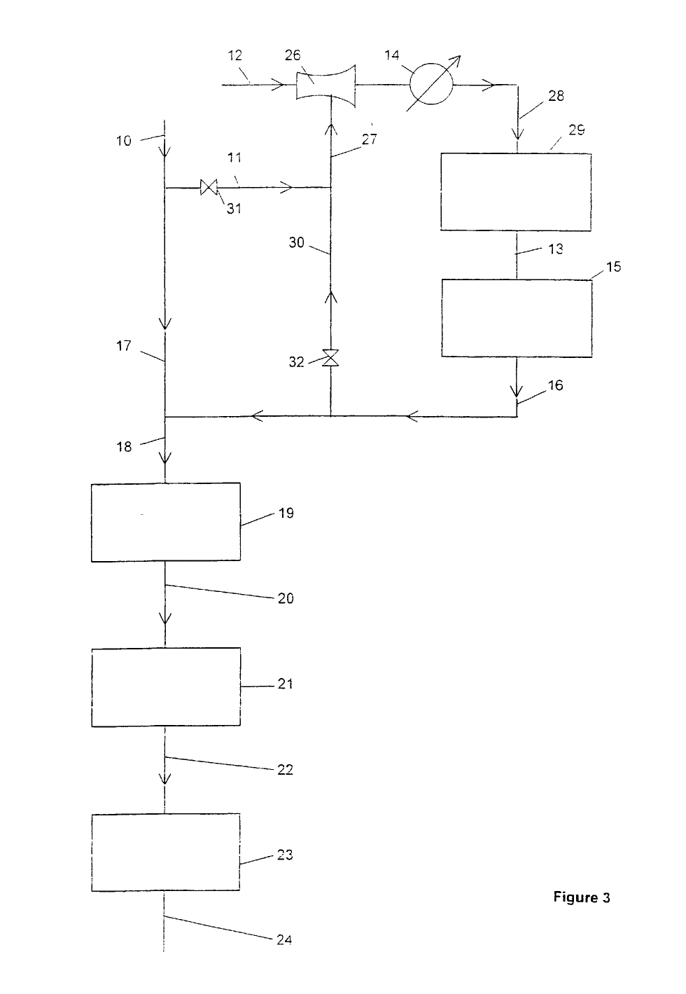

FIG. 3 is a diagrammatic flow sheet of a process in accordance with a third embodiment of the invention.

Referring to FIG. 1, a hydrocarbon feedstock is supplied via line 10. Part, for example 8% of the total, is taken via line 11 and mixed with steam supplied via line 12 and the resulting mixture fed via line 13 and heat exchanger 14 at an elevated temperature e.g. 400° C. to a bed 15 of a low temperature reforming catalyst wherein reforming takes place adiabatically. The reformed gas leaves bed 15 via line 16 and is re-united with the remainder of the hydrocarbon feedstock which bypasses bed 15 via line 17. The resulting mixture, which typically contains about 1% by volume of hydrogen, is then fed via line 18 to a bed 19 of a hydro-desulphurisation catalyst wherein hydro-desulphurisation takes place and the organic sulphur compounds are converted to hydrogen sulphide. The hydro-desulphurised gas is then fed, via line 20, through a bed 21 of a particulate hydrogen sulphide absorbent and then via line 22, through a bed 23 of a copper/zinc oxide absorbent to effect further sulphur removal to give a desulphurised product stream 24

If desired a further bed of the hydrogen sulphide absorbent may be disposed in line 10 or line 11 to effect removal of any hydrogen sulphide in the hydrocarbon feed prior to contact with the low temperature reforming catalyst 15

It will be appreciated that a throttle 25 needs to be disposed in line 17 so that some of the hydrocarbon feed is diverted through bed 15.

In a calculated example 100 parts by volume of natural gas are supplied to line 10 at a pressure of 2 bar abs and a temperature of 400° C. The throttle 25 is arranged so that 8 parts by volume of the natural gas is diverted along line 11 and is mixed with 7 parts by volume of steam at 400° C. at a pressure of 2 bar abs. The mixture is fed through the bed of catalyst 15 whereupon reforming takes place to give about 17 4 parts by volume of a gas stream 16 containing about 8.1 parts by volume of a methane. about 1 1 parts by volume hydrogen, about 7.7 parts by volume steam, with the balance being carbon oxides Upon mixture with the remaining 92 parts by volume of the hydrocarbon feedstock bypassing bed 15 via throttle 25 and line 17, the resultant gas stream contains about 1 0% by volume hydrogen.

In a second alternative embodiment depicted in FIG. 2, an ejector 26, working on the venturi principle is provided in the steam line 12 and the throttle 25 of the FIG. 1 embodiment is omitted. This ejector includes a constriction and expansion region through which the steam passes providing a region of lower pressure into which the hydrocarbon is fed via line 11 The use of an ejector to control hydrocarbon feed to the low temperature reformer 15 may be preferable where the use of a throttle control is difficult. The resulting mixture fed via line 13 and heat exchanger 14 to a bed 15 of a low temperature reforming catalyst wherein reforming takes place adiabatically. The remainder of the process is identical to that depicted in FIG. 1.

Although it may be inconvenient to recycle hydrogen from downstream of the processing of the desulphurised stream 24, in some cases it may be possible to arrange for recycle of sufficient of the adiabatically reformed stream 16 to provide sufficient hydrogen to enable the hydrocarbon feedstock fed to the adiabatic reforming step to be desulphurised

Thus, as illustrated in the third embodiment shown in FIG. 3, an ejector 26 provided in the steam line 12 provides a region of lower pressure into which the hydrocarbon is fed via lines 10, 11 and 27 The steam/hydrocarbon mixture is then pre-heated in heat exchanger 14 and fed, via line 28, to a first bed of a hydro-desulphurisation catalyst followed by a bed of a hydrogen sulphide absorbent, both disposed in a vessel 29. The desulphurised steam/hydrocarbon mixture is then fed via line 13 to the bed 15 of low-temperature reforming catalyst. Part of the reformed gas leaving bed 15 via line 16 is recycled to the ejector 26 via line 30 to provide the hydrogen required for hydro-desulphurisation of the hydrocarbon feedstock fed to bed 15 Valves 31 and 32 are provided in lines 11 and 30 respectively to control the amounts of the feedstock stream and recycled hydrogen-containing stream fed to the ejector 26.

1. A process for the desulphurisation of a hydrocarbon feedstock containing sulphur compounds comprising subjecting a portion of said feedstock to a pre-treatment step of partial oxidation, optionally in the presence of a catalyst, or adiabatic low temperature catalytic steam reforming, thereby forming a gas stream containing hydrogen, and then passing the resultant hydrogen-containing pre-treated gas stream together with the remainder, of said hydrocarbon feedstock, through a bed of a hydro-desulphurisation catalyst and then through a bed of a particulate absorbent capable of absorbing hydrogen sulphide.

2. A process according to claim 1 wherein a minor portion of the feedstock is subjected to the pre-treatment step.

3. A process according to claim 1 wherein the portion of the feedstock that is subjected to the pre-treatment step is passed through a bed of a particulate absorbent capable of absorbing hydrogen sulphide and/or organic sulphur compounds prior to the pre-treatment

4. A process according to claim 3 wherein the portion of the feedstock that is subjected to the pre-treatment step is passed though a first bed of a hydro-desulphurisation catalyst prior to passage through the particulate absorbent, and part of the hydrogen-containing pre-treated gas stream is added to that portion of the feedstock prior to passage through said first bed of a hydro-desulphurisation catalyst.

5. A process according to claim 1 wherein a stream of steam is passed through ejector means into which the portion of said feedstock is introduced, whereby said stream of steam passing through said ejector means effects the driving force required to cause said portion to flow, with said stream of steam, through said pre-treatment step.

6. A process according to claim 1 wherein the hydrocarbon feedstock has a total sulphur content of 1 to 500 ppm by weight of which 50 to 90% is organic sulphur.

7. A process according to claim 1 wherein the pre-treatment comprises adiabatic low temperature catalytic steam reforming wherein a mixture of the hydrocarbon feedstock and steam is passed at an inlet temperature in the range 300 to 600° C., through a bed of a low temperature reforming catalyst

8. A process according to claim 7 wherein the low temperature reforming catalyst contains at least 40% by weight of nickel.

9. A process according to claim 7 wherein the amount of steam is preferably 0.5 to 3 moles of steam per gram atom of hydrocarbon carbon in the portion of the hydrocarbon stream fed to the pre-treatment stage.

10. A process according to claim 1 wherein the hydrocarbon feedstock contains at least 20 ppm by weight of sulphur and the pre-treatment comprises non-catalytic partial oxidation

11. A process according to claim 1 wherein the proportion of feedstock subjected to the pre-treatment and the pre-treatment conditions are such that the mixture of the pre-treated gas stream and the remainder, if any, of the hydrocarbon feedstock contains at least 0.5% by volume of hydrogen.

12. A process according to claim 1 wherein the hydro-desulphurisation is effected using a bed of a catalyst comprising cobalt and/or nickel molybdate at an inlet temperature in the range 150 to 400° C.
